(19) United States
(12) Patent Application Publication
(10) Pub. No.: US 2025/0299396 A1
(43) Pub. Date: Sep. 25, 2025

(54) CONTROLLABLE VISUAL TEXT GENERATION WITH ADAPTER-ENHANCED DIFFUSION MODELS

(71) Applicant: ADOBE INC., San Jose, CA (US)

(72) Inventors: Jiabao Ji, Santa Barbara, CA (US); Zhaowen Wang, San Jose, CA (US); Zhifei Zhang, San Jose, CA (US); Brian Lynn Price, Grove, UT (US)

(21) Appl. No.: 18/612,100

(22) Filed: Mar. 21, 2024

(51) Int. Cl. G06T 11/60; G06F 40/109; G06V 20/62; G06V 30/10

(52) U.S. Cl. CPC G06T 11/60; G06F 40/109; G06V 20/63; G06V 30/10

(57) ABSTRACT

A method, apparatus, non-transitory computer readable medium, and system for image generation include obtaining a text content image and a text style image. The text content image is encoded to obtain content guidance information and the text style image is encoded to obtain style guidance information. Then a synthesized image is generated based on the content guidance information and the style guidance information. The synthesized image includes text from the text content image having a text style from the text style image.

### BACKGROUND

The following relates generally to image processing, and more specifically to image generation using machine learning. Digital image processing refers to the use of a computer to edit a digital image using an algorithm or a processing network. In some cases, image processing software can be used for various tasks, such as image editing, image restoration, image generation, etc. Recently, machine learning models have been used in advanced image processing techniques. Among these machine learning models, diffusion models and other generative models such as generative adversarial networks (GANs) have been used for various tasks including generating images with perceptual metrics, generating images in conditional settings, image inpainting, and image manipulation.

Image generation, a subfield of image processing, includes the use of diffusion models to synthesize images. Diffusion models can be used for various image generation tasks including image super-resolution, generation of images with perceptual metrics, conditional generation (e.g., generation based on text guidance), image inpainting, and image manipulation. Specifically, diffusion models are trained to take random noise as input and generate unseen images with features similar to the training data.

### SUMMARY

The present disclosure describes systems and methods for image generation. Embodiments of the present disclosure include an image generation apparatus configured to receive a text content image and a text style image as inputs and generate a synthesized image using an image generation model. In some examples, the text content image comprises content guidance information such as one or more characters and layout of text. The text style image comprises style guidance information such as font and color. For text editing tasks (e.g., replace original text in an image with target text and desired style), some embodiments provide an image generator, a text content adapter, and a text style adapter. The text content adapter and the text style adapter provide the content guidance information and the style guidance, respectively, to condition text editing and image synthesis performed by the image generator.

A method, apparatus, and non-transitory computer readable medium for image generation are described. One or more embodiments of the method, apparatus, and non-transitory computer readable medium include obtaining a text content image and a text style image; encoding, using a text content adapter of an image generation model, the text content image to obtain content guidance information; encoding, using a text style adapter of the image generation model, the text style image to obtain style guidance information; and generating, using the image generation model, a synthesized image based on the content guidance information and the style guidance information, wherein the synthesized image includes text from the text content image having a text style from the text style image.

A method, apparatus, and non-transitory computer readable medium for image generation are described. One or more embodiments of the method, apparatus, and non-transitory computer readable medium include initializing an image generation model; obtaining a training set including a ground-truth image, a text content image, and a text style image; and training, using the training set, the image generation model to generate images that include text having a target text style from the text style image.

An apparatus and method for image generation are described. One or more embodiments of the apparatus and method include at least one processor; at least one memory including instructions executable by the at least one processor; and a machine learning model comprising parameters in the at least one memory, wherein the machine learning model comprises a text content adapter of an image generation model trained to encode a text content image to obtain content guidance information, a text style adapter of the image generation model trained to encode a text style image to obtain style guidance information, and an image generator of the image generation model trained to generate a synthesized image based on the content guidance information and the style guidance information, wherein the synthesized image includes text from the text content image and a text style from the text style image.

### BRIEF DESCRIPTION OF THE DRAWINGS

FIG. 1 shows an example of an image generation system according to aspects of the present disclosure.

FIG. 2 shows an example of a method for controllable text generation according to aspects of the present disclosure.

FIGS. 3 and 4 show examples of text editing according to aspects of the present disclosure.

FIG. 5 shows an example of text-to-image generation according to aspects of the present disclosure.

FIG. 6 shows an example of a method for image generation according to aspects of the present disclosure.

FIG. 7 shows an example of an image generation apparatus according to aspects of the present disclosure.

FIG. 8 shows an example of an image generation model comprising a control network according to aspects of the present disclosure.

FIG. 9 shows an example of a guided latent diffusion model according to aspects of the present disclosure.

FIGS. 10 and 11 show examples of an image generation model according to aspects of the present disclosure.

FIGS. 12 and 13 show examples of methods for training an image generation model according to aspects of the present disclosure.

FIG. 14 shows an example of a computing device according to aspects of the present disclosure.

### DETAILED DESCRIPTION

The present disclosure describes systems and methods for image generation. Embodiments of the present disclosure include an image generation apparatus configured to receive a text content image and a text style image as inputs and generate a synthesized image using an image generation model. In some examples, the text content image comprises content guidance information such as one or more characters and layout of text. The text style image comprises style guidance information such as font and color. For text editing tasks (e.g., replace original text in an image with target text and desired style), some embodiments provide an image generator, a text content adapter, and a text style adapter. The text content adapter and the text style adapter provide the content guidance information and the style guidance, respectively, to condition text editing and image synthesis performed by the image generator.

Diffusion models are a class of generative neural networks that can be trained to generate new data with features similar to features found in training data. Diffusion models can be used in image completion tasks, such as image inpainting. In some examples, however, diffusion models may generate poor results when they are limited to taking only text information as a condition for image generation tasks. Conventional text editing modes are limited to changing text content and do not work well in scenarios where the models are used to modify text style as well based on a style reference image. In some cases, the style reference image contains an incompatible background compared to the original text image and conventional models generate incoherent and less desirable results.

Embodiments of the present disclosure include an image generation apparatus configured to edit text in a text content image and replace the text with target text, where the target text follows a desired text style from a text style image. The image generation apparatus generates a synthesized image based on content guidance information derived from the text content image and style guidance information derived from the text style image. For example, the synthesized image includes text from the text content image and the desired text style from the text style image. The synthesized image looks coherent and realistic.

The image generation apparatus is configured for text editing and text-to-image generation tasks (i.e., for images that show text). For text editing (e.g., replace existing text in a text image), in some embodiments, an image generation model comprises an image generator (e.g., a diffusion model) and multiple different adapters including a text content adapter, text style adapter, and a background adapter. The three adapters provide content guidance information, style guidance information, and background guidance information, respectively, as inputs to an image generator such as a diffusion model. In some examples, the image generator comprises U-Net and the different adapter networks are initialized as a control network or ControlNet adapter. At training, weights of the three adapters are optimized.

As for text-to-image generation process, only text content adapter and text style adapter are activated. That is, the background adapter is not activated because there is no background image and the model relies on the image generator to synthesize an image based on a text prompt. A text encoder is used to encode the text prompt to obtain text guidance information. The image generator (e.g., U-Net) receives text guidance information, content guidance information, and style guidance information as inputs. Then, image generator generates a synthesized image.

The present disclosure describes systems and methods that improve on conventional image generation models by providing more accurate depiction of text in output images. Furthermore, the output images can include text that matches a target font and style. That is, users can achieve more precise control over text-related attributes such as content, layout and font style compared to conventional text editing models. Embodiments achieve this improved accuracy and control by generating content guidance information and the style guidance information for an image generation model using separate text and style network control adapters.

Embodiments of the present disclosure ensure that synthesized images display target text accurately and ensure the blending between the target text and the image background is seamless. For example, the target text follows a style from a style reference image and fits well in the overall scene at a target location indicated by the text content image. Accordingly, the synthesized images look more coherent and realistic. The unique implementation disentangles different guidance information obtained from a text image, leading to separate control using different adapters. The image generation model can be easily extended to include additional adapters to process even more fine-grained information (e.g., font type, stroke thickness). Users have increased and more accurate control over text editing and text-to-image generation.

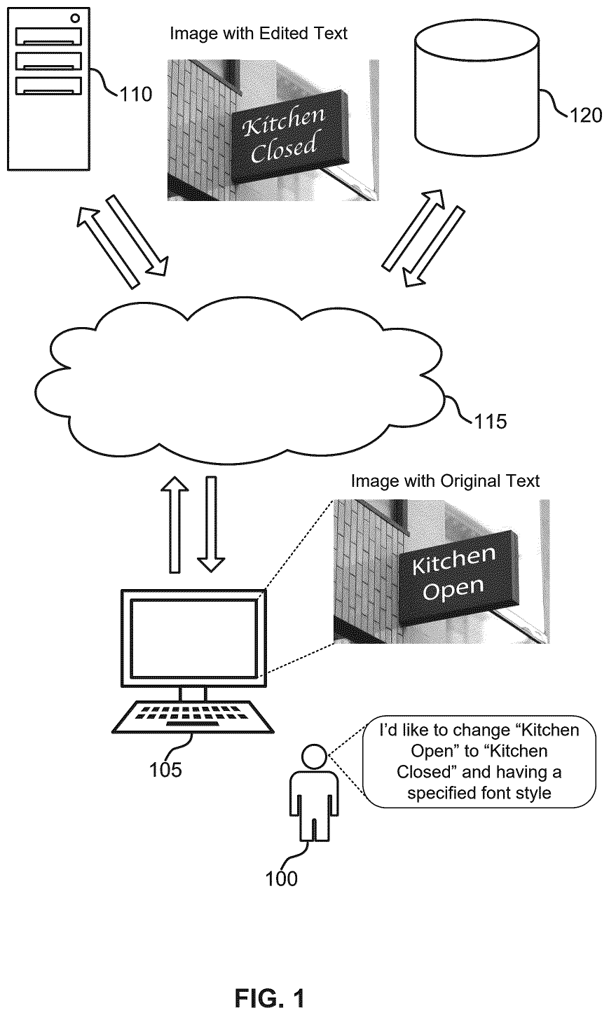

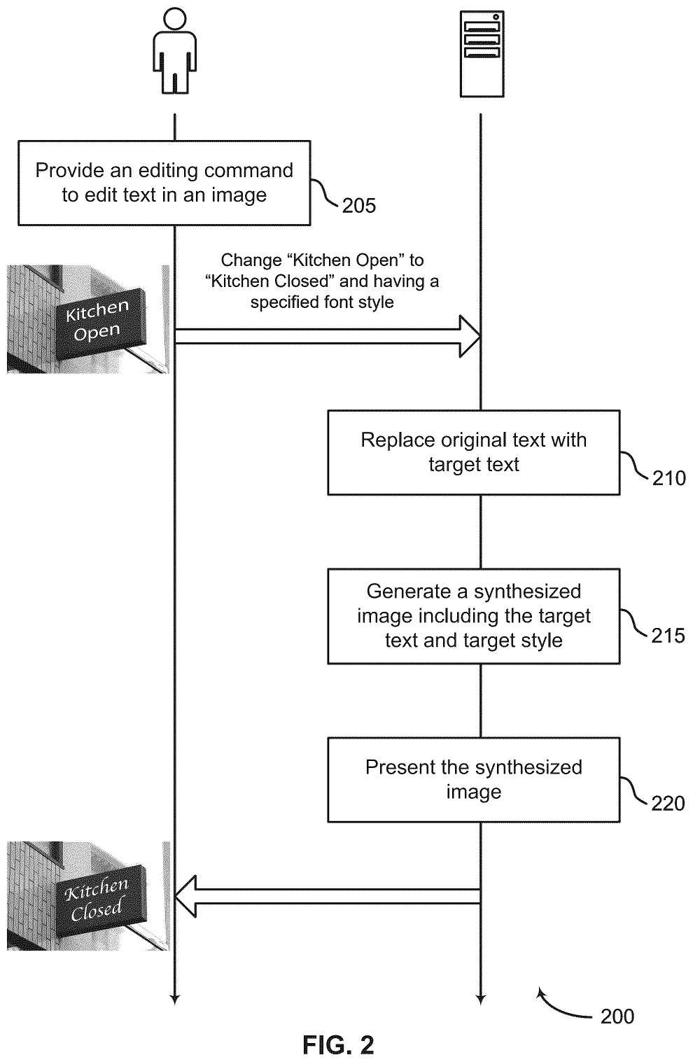

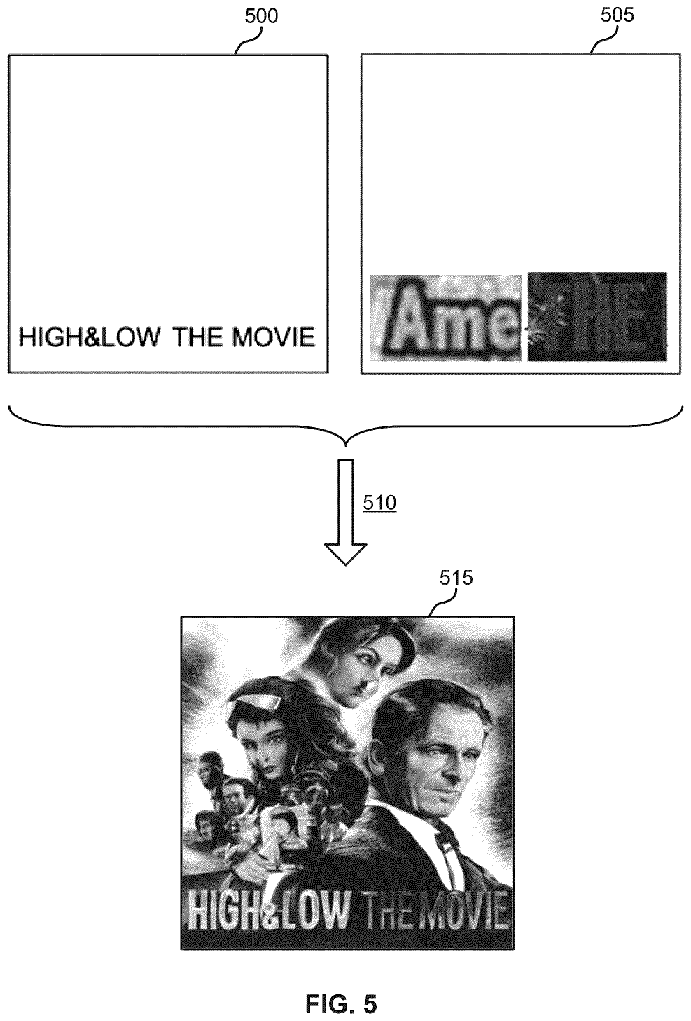

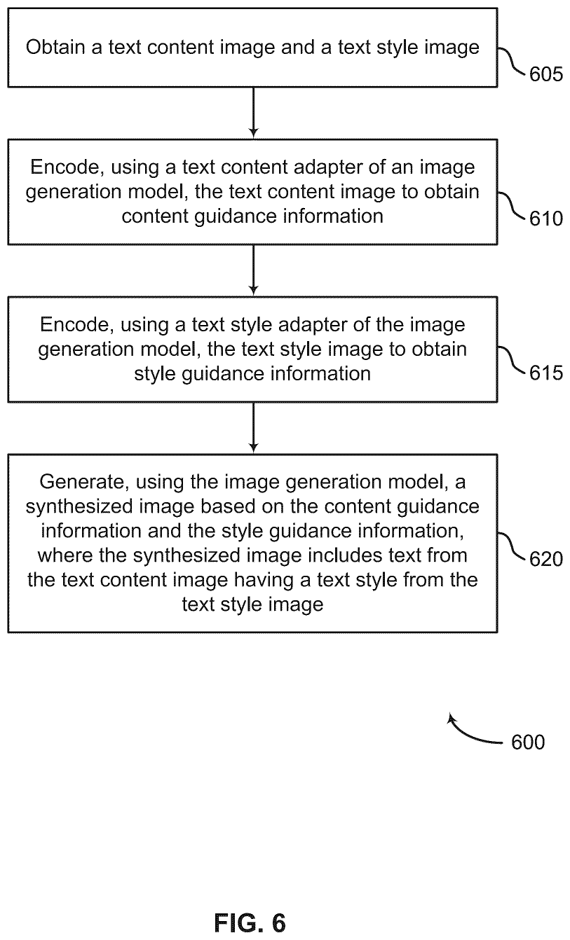

In some examples, an image generation apparatus based on the present disclosure obtains a text content image and a text style image, and then generates a synthesized image that includes text from the text content image and a text style from the text style image. The text style image may be referred to as a style reference image. In some cases, obtaining a style reference image comprises cropping the style reference image from a source image. Examples of application in the text editing context are provided with reference to FIGS. 2-4. An example application in the text-to-image generation context is provided with reference to FIG. 5. Details regarding the architecture of an example image generation system are provided with reference to FIGS. 1 and 7-11. Details regarding the image generation process are provided with reference to FIG. 6.

### Text Editing and Image Generation

In FIGS. 1-6, a method, apparatus, and non-transitory computer readable medium for image generation are described. One or more embodiments of the method, apparatus, and non-transitory computer readable medium include obtaining a text content image and a text style image; encoding, using a text content adapter of an image generation model, the text content image to obtain content guidance information; encoding, using a text style adapter of the image generation model, the text style image to obtain style guidance information; and generating, using the image generation model, a synthesized image based on the content guidance information and the style guidance information, wherein the synthesized image includes text from the text content image having a text style from the text style image.

Some examples of the method, apparatus, and non-transitory computer readable medium further include encoding, using a background adapter of the image generation model, a background image to obtain background guidance information, wherein the synthesized image is generated based on the background guidance information. In some examples, the background image indicates a location of the text.

Some examples of the method, apparatus, and non-transitory computer readable medium further include encoding, using a text encoder of the image generation model, a text prompt to obtain text guidance information, wherein the synthesized image is generated based on the text guidance information.

Some examples of the method, apparatus, and non-transitory computer readable medium further include determining, using a character recognition component, a character location of each character in the text content image, wherein the content guidance information is based on the character location.

Some examples of the method, apparatus, and non-transitory computer readable medium further include generating a style vector map that indicates a location of the text style in the text style image, wherein the style guidance information is based on the style vector map.

Some examples of the method, apparatus, and non-transitory computer readable medium further include performing a reverse diffusion process. Some examples of the method, apparatus, and non-transitory computer readable medium further include providing the content guidance information and the style guidance information to an up-sampling layer of the image generation model. In some examples, the text content adapter is trained using a character recognition loss.

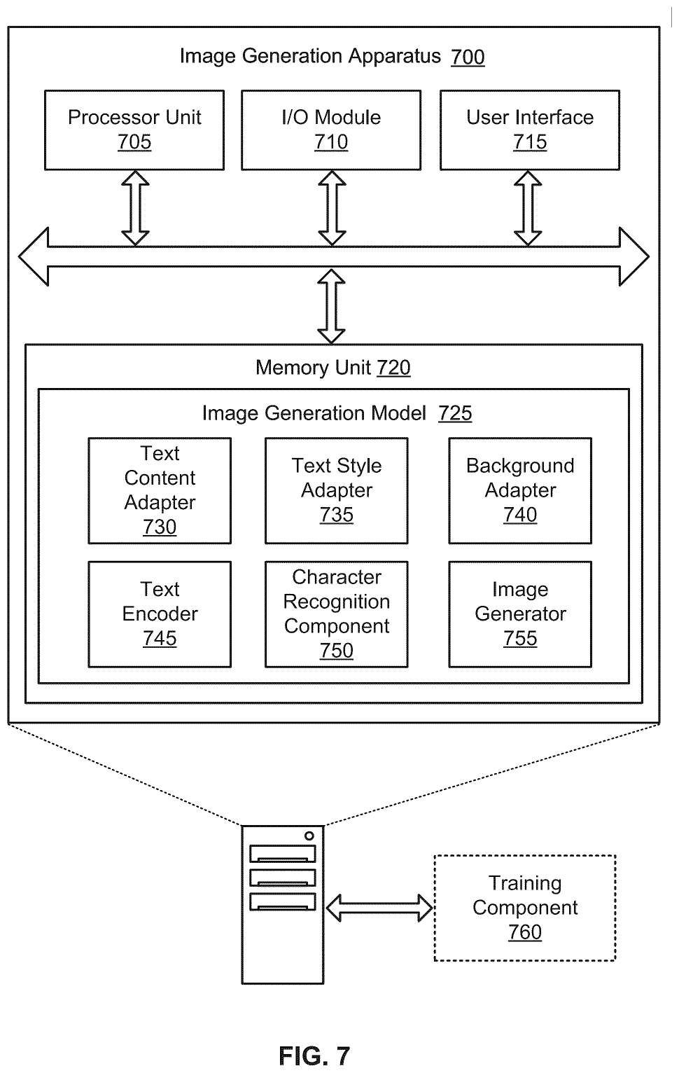

FIG. 1 shows an example of an image generation system according to aspects of the present disclosure. The example shown includes user 100, user device 105, image generation apparatus 110, cloud 115, and database 120. Image generation apparatus 110 is an example of, or includes aspects of, the corresponding element described with reference to FIG. 7.

In an example shown in FIG. 1, a query is provided by user 100 and transmitted to image generation apparatus 110, e.g., via user device 105 and cloud 115. The query is an instruction or a command received from user 100. For example, the query is “change ‘Kitchen Open’ to ‘Kitchen Closed’ and having a specified font style”. In some cases, image generation apparatus 110 obtains a text content image and a text style image, via cloud 115, from database 120. In some cases, a text content image and a text style image are uploaded by user 100 via user device 105. The text “Kitchen Closed” (i.e., target text with specified layout) is from the text content image. The specified font style is from the text style image.

In some examples, image generation apparatus 110 encodes the text content image to obtain content guidance information. Image generation apparatus 110 encodes the text style image to obtain style guidance information. Image generation apparatus 110 generates a synthesized image based on the content guidance information and the style guidance information. For example, the synthesized image is an image with edited text. The synthesized image includes text from the text content image and a text style from the text style image. Image generation apparatus 110 returns the synthesized image to user 100 via cloud 115 and user device 105.

User device 105 may be a personal computer, laptop computer, mainframe computer, palmtop computer, personal assistant, mobile device, or any other suitable processing apparatus. In some examples, user device 105 includes software that incorporates an image processing application (e.g., an image generator, an image editing tool, a text editing tool). In some examples, the image processing application on user device 105 may include functions of image generation apparatus 110.

A user interface may enable user 100 to interact with user device 105. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a user interface may be represented in code which is sent to the user device 105 and rendered locally by a browser.

Image generation apparatus 110 includes a computer implemented network comprising a text content adapter, a text style adapter, a background adapter, a text encoder, a character recognition component, and an image generator. Image generation apparatus 110 may also include a processor unit, a memory unit, an I/O module, a user interface, and a training component. The training component is used to train a machine learning model (or an image generation model) comprising an image generator and one or more adapters. Additionally, image generation apparatus 110 can communicate with database 120 via cloud 115. In some cases, the architecture of the image generation network is also referred to as a network, a machine learning model, or a network model. Further detail regarding the architecture of image generation apparatus 110 is provided with reference to FIGS. 7-11. Further detail regarding the operation of image generation apparatus 110 is provided with reference to FIGS. 2 and 6.

In some cases, image generation apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., candidate text style images, candidate text content images, a training set including one or more ground-truth images) in a specified format known as a schema. Database 120 may be structured as a single database, a distributed database, multiple distributed databases, or an emergency backup database. In some cases, a database controller may manage data storage and processing in database 120. In some cases, a user interacts with database controller. In other cases, database controller may operate automatically without user interaction.

FIG. 2 shows an example of a method 200 for controllable text generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, the user provides an editing command to edit text in an image. In some cases, the operations of this step refer to, or may be performed by, a user using a user device as described with reference to FIG. 1. For example, the editing command is “change ‘Kitchen Open’ to ‘Kitchen Closed’ and having a specified font style”. The user wants to change the term “Open” to “Closed” and at the same time modify a font style of “Kitchen Open” to another font style (i.e., a target style).

At operation 210, the system replaces original text in the image with target text at a same location of the original text. In some cases, the operations of this step refer to, or may be performed by, an image generation apparatus as described with reference to FIGS. 1 and 7. In the above example, the term “Closed” is to replace original text “Closed” at the same location in a seamless manner. That is, the replaced term maintains the same location in the overall image layout.

At operation 215, the system generates a synthesized image including the target text and the target style. In some cases, the operations of this step refer to, or may be performed by, an image generation apparatus as described with reference to FIGS. 1 and 7. In some examples, the synthesized image includes text from a text content image and a text style from a text style image. The text content image and the text style image are provided by the user, e.g., transmitted from a database or a user device. The text style is the target style as shown in the text style image.

At operation 220, the system presents the synthesized image to the user. In some cases, the operations of this step refer to, or may be performed by, an image generation apparatus as described with reference to FIGS. 1 and 7. Additional editing can be made to the text of the synthesized image in the same way. For example, the user provides a subsequent editing command to edit an additional text in the synthesized image.

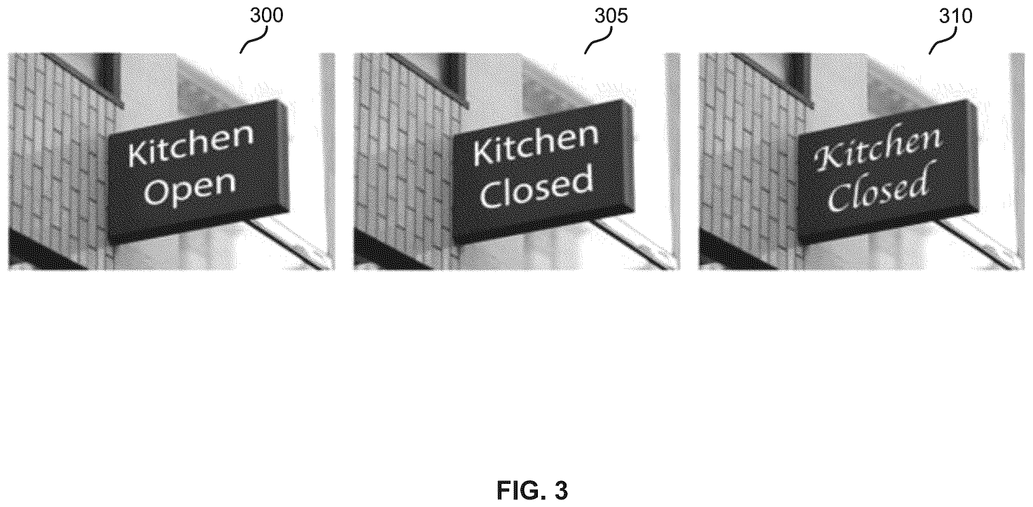

FIG. 3 shows an example of text editing according to aspects of the present disclosure. The example shown includes original image 300, edited image 305, and synthesized image 310. In this example, original image 300 includes text “Kitchen Open”. In the edited image 305, the word “Open” is changed to “Closed”. In the synthesized image 310, the word “Open” is changed to “Closed” while a different style is applied to the text content. The style/font of synthesized image 310 is different from the style/font of original image 300.

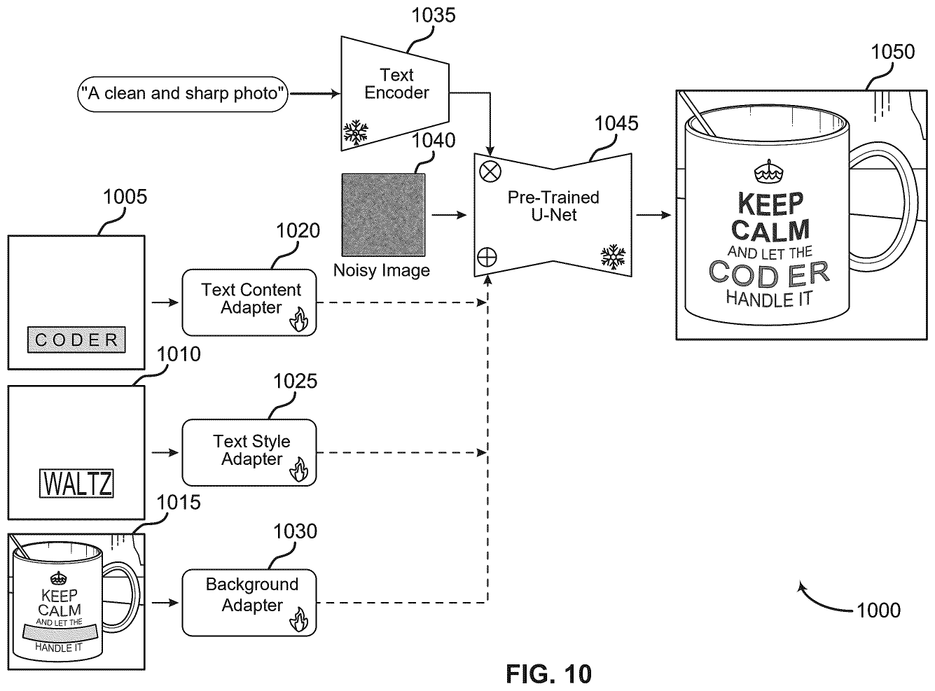

In some cases, to preserve the original text style while editing the text content, an image editing tool based on the present disclosure (e.g., image generation apparatus with reference to FIGS. 1 and 7) crops a style image out as a style reference image and renders a text-layout image with the target text at the location of the original text. A background image, cropped text image, and text-layout image are the inputs to background adapter, text style adapter, and text content adapter, respectively (with reference to FIG. 10). The image editing tool generates target text at the specified location following a target style/font.

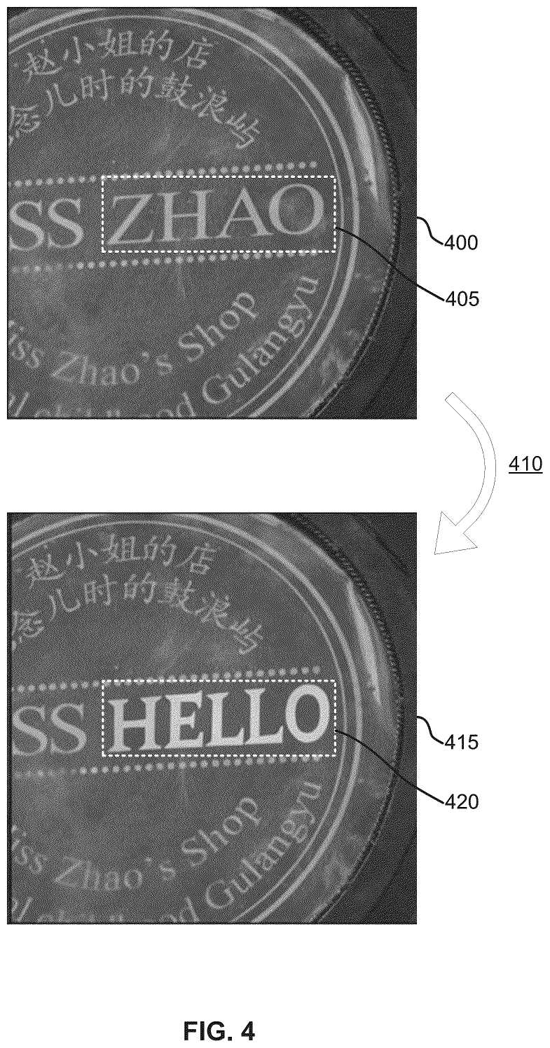

FIG. 4 shows an example of text editing according to aspects of the present disclosure. The example shown includes original image 400, original text 405, image generation model 410, synthesized image 415, and edited text 420.

In this example, original image 400 includes text “SS ZHAO”. In the synthesized image 415, the word “ZHAO” is changed to “HELLO” while a different style is applied to edited text 420. That is, the style/font of edited text 420 in synthesized image 415 is different from the style/font of original text 405 in original image 400.

Image generation model 410 is an example of, or includes aspects of, the corresponding element described with reference to FIGS. 5, 7, 10, and 11. Synthesized image 415 is an example of, or includes aspects of, the corresponding element described with reference to FIGS. 5, 10, and 11.

According to some embodiments, image generation model 410 obtains a text content image and a text style image. In some examples, image generation model 410 generates a synthesized image 415 based on the content guidance information and the style guidance information, where the synthesized image 415 includes text from the text content image and a text style from the text style image. In some examples, image generation model 410 provides the content guidance information and the style guidance information to an up-sampling layer of the image generation model 410.

According to some embodiments, image generation model 410 extracts a text content location from the training background image, where the image generation model 410 is trained to generate the images based on the training background image and the text content location.

According to some embodiments, image generation model 410 is trained to encode a text content image to obtain content guidance information, a text style adapter of the image generation model 410 trained to encode a text style image to obtain style guidance information, and an image generator of the image generation model 410 trained to generate a synthesized image 415 based on the content guidance information and the style guidance information. The synthesized image 415 includes text from the text content image and a text style from the text style image.

FIG. 5 shows an example of text-to-image generation according to aspects of the present disclosure. The example shown includes text content image 500, text style image 505, image generation model 510, and synthesized image 515. Image generation model 510 is an example of, or includes aspects of, the corresponding element described with reference to FIGS. 4, 7, 10, and 11.

FIG. 5 shows an example of using image generation model 510 for text-to-image generation tasks. In an example, image generation model 510 generates a poster image (e.g., synthesized image 515) following user-provided instructions, text content image 500 (text layout), and text style image 505 (style reference). Text content image 500 includes target text, i.e., “HIGH&LOW THE MOVIE”. Text content image 500 includes text layout information, that is, target location of the target text in relation to the background (e.g., in relation to the rest of the synthesized image 515). The target text “HIGH&LOW THE MOVIE is located at the bottom of text content image 500. Additionally, text style image 505 includes a target style that is to be applied to the target text.

In an embodiment, image generation model 510 receives text content image 500, text style image 505, and a text prompt as inputs. Here, an example of the text prompt (i.e., user instruction) is “a high-quality movie poster”. Image generation model 510 generates synthesized image 515 that includes the target text at a specified location and the target style.

In an embodiment, image generation model 510 deactivates a background adapter and just uses a text content adapter and a text style adapter (with reference to adapters described in FIG. 7). Image generation model 510 generates the text at a specified location following the style reference. Due to text-to-image ability of an image generator (e.g., a diffusion model), image generation model 510 generates a high-fidelity background to complete the rest of the synthesized image 515. For example, the background of synthesized image 515 is generated by image generation model 510.

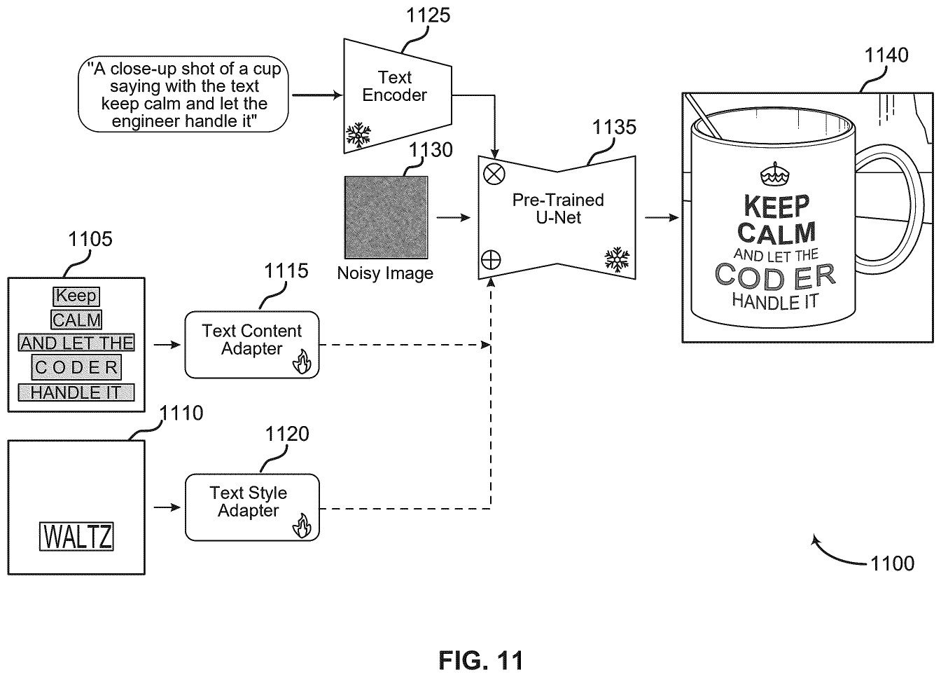

Text content image 500 is an example of, or includes aspects of, the corresponding element described with reference to FIGS. 10 and 11. Text style image 505 is an example of, or includes aspects of, the corresponding element described with reference to FIGS. 10 and 11. Synthesized image 515 is an example of, or includes aspects of, the corresponding element described with reference to FIGS. 4, 10, and 11.

FIG. 6 shows an example of a method 600 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system obtains a text content image and a text style image. In some cases, the operations of this step refer to, or may be performed by, an image generation model as described with reference to FIGS. 4, 5, 7, 10, and 11. In some examples, the text content image includes target text (e.g., one or more characters or phrases) and text layout information. The text layout information includes location of the target text in relation to the background and other text or objects (the location of the target text to be placed in a synthesized image). The text style image includes a text style or text font that is to be applied to the target text. In some cases, the text style depicted in the text style image is different from the style of the text in the text content image.

At operation 610, the system encodes, using a text content adapter of an image generation model, the text content image to obtain content guidance information. In some cases, the operations of this step refer to, or may be performed by, a text content adapter as described with reference to FIGS. 7, 10, and 11.

In some embodiments, text-to-image diffusion models are configured to process visual text editing and can be extended to text-to-image generation. The image generation model includes an image generator (e.g., a text-to-image model) and adapters. For example, the image generator is a diffusion model pre-trained on web scale real images, which takes instructions as input condition and generates high-fidelity images following the instructions.

To perform text editing, the image generation model includes multiple adapters to process different components of text images, e.g., text content, text style, and background image, separately. In this way, user control of the image generation process is increased by controlling corresponding adapter.

At operation 615, the system encodes, using a text style adapter of the image generation model, the text style image to obtain style guidance information. In some cases, the operations of this step refer to, or may be performed by, a text style adapter as described with reference to FIGS. 7, 10, and 11.

In some embodiments, the text content adapter and the text style adapter are spatial-aware and enable users to provide a text layout image to control the location of target text. During training, the image generator is fixed (i.e., parameters are not updated) and the adapters are trained. This saves training costs and the image generation ability of the image generator is preserved. The adapters (text content adapter, text style adapter, background background) can be jointly used at inference time to perform different tasks. In some cases, background adapter is optional and may be deactivated. Text images are generated with just the text content adapter and the text style adapter activated. The output from the text style adapter includes style guidance information related to target text style.

At operation 620, the system generates, using the image generation model, a synthesized image based on the content guidance information and the style guidance information, where the synthesized image includes text from the text content image and the text has a text style from the text style image. In some cases, the operations of this step refer to, or may be performed by, an image generation model as described with reference to FIGS. 4, 5, 7, 10, and 11. In an embodiment, the synthesize image includes text from the text content image to replace the original text for text editing tasks. For example, referring to FIG. 10, the text content image includes phrase “CODER” that is to be placed at the same location as the original text in the synthesized image. The text style image includes a target style that is represented by font style of phrase “WALTZ”. The font style of “WALTZ” is different from font style of “CODER”. Detail regarding incorporating a text content adapter, a text style adapter, and a background adapter for text editing will be described in FIG. 10. Some embodiments involve generating a synthesized image based on a text prompt and a text style image (i.e., the background adapter is deactivated) for text to image generation tasks. Detail regarding incorporating a text content adapter and a text style adapter for image generation will be described in FIG. 11.

### Network Architecture

In FIGS. 7-11, an apparatus and method for image generation are described. One or more embodiments of the apparatus and method include at least one processor; at least one memory including instructions executable by the at least one processor; and a machine learning model comprising parameters in the at least one memory, wherein the machine learning model comprises a text content adapter of an image generation model trained to encode a text content image to obtain content guidance information, a text style adapter of the image generation model trained to encode a text style image to obtain style guidance information, and an image generator of the image generation model trained to generate a synthesized image based on the content guidance information and the style guidance information, wherein the synthesized image includes text from the text content image and a text style from the text style image.

Some examples of the apparatus and method further include a background adapter of the image generation model trained to encode a background image to obtain background guidance information, wherein the synthesized image is generated based on the background guidance information.

In some examples, the text content adapter and the text style adapter comprise a control network that is initialized using parameters from the image generator. In some examples, the image generator comprises a diffusion model.

Some examples of the apparatus and method further include a multi-modal encoder configured to encode a text prompt to obtain text guidance information, wherein the synthesized image is generated based on the text guidance information.

FIG. 7 shows an example of an image generation apparatus 700 according to aspects of the present disclosure. The example shown includes image generation apparatus 700, processor unit 705, I/O module 710, user interface 715, memory unit 720, image generation model 725, and training component 760. Image generation apparatus 700 is an example of, or includes aspects of, the corresponding element described with reference to FIG. 1.

Processor unit 705 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor unit 705 is configured to operate a memory array using a memory controller. In other cases, a memory controller is integrated into the processor. In some cases, processor unit 705 is configured to execute computer-readable instructions stored in a memory to perform various functions. In some embodiments, processor unit 705 includes special purpose components for modem processing, baseband processing, digital signal processing, or transmission processing.

Examples of memory unit 720 include random access memory (RAM), read-only memory (ROM), or a hard disk. Examples of memory unit 720 include solid state memory and a hard disk drive. In some examples, memory unit 720 is used to store computer-readable, computer-executable software including instructions that, when executed, cause a processor to perform various functions described herein. In some cases, memory unit 720 contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within memory unit 720 store information in the form of a logical state.

In some examples, at least one memory unit 720 includes instructions executable by the at least one processor unit 705. Memory unit 720 includes image generation model 725 or stores parameters of image generation model 725.

I/O module 710 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 710 includes a user interface. A user interface may enable a user to interact with a device. In some embodiments, the user interface may include an audio device, such as an external speaker system, an external display device such as a display screen, or an input device (e.g., remote control device interfaced with the user interface directly or through an I/O controller module). In some cases, a user interface may be a graphical user interface (GUI). In some examples, a communication interface operates at the boundary between communicating entities and the channel and may also record and process communications. Communication interface is provided herein to enable a processing system coupled to a transceiver (e.g., a transmitter and/or a receiver). In some examples, the transceiver is configured to transmit (or send) and receive signals for a communications device via an antenna.

According to some embodiments of the present disclosure, image generation apparatus 700 includes a computer implemented artificial neural network (ANN) for text editing and image generation. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted.

Accordingly, during the training process, the parameters and weights of the image generation model 725 are adjusted to increase the accuracy of the result (i.e., by attempting to minimize a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to some embodiments, image generation apparatus 700 includes a convolutional neural network (CNN) for image generation. CNN is a class of neural networks that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

In one embodiment, image generation model 725 includes text content adapter 730, text style adapter 735, background adapter 740, text encoder 745, character recognition component 750, and image generator 755. Image generation model 725 is an example of, or includes aspects of, the corresponding element described with reference to FIGS. 4, 5, 10, and 11.

According to some embodiments, text content adapter 730 of an image generation model 725 encodes the text content image to obtain content guidance information. In some examples, the text content adapter 730 and the text style adapter 735 include a control network that is initialized using parameters from the image generator 755. Text content adapter 730 is an example of, or includes aspects of, the corresponding element described with reference to FIGS. 10 and 11.

According to some embodiments, text style adapter 735 of the image generation model 725 encodes the text style image to obtain style guidance information. In some examples, text style adapter 735 generates a style vector map that indicates a location of the text style in the text style image, where the style guidance information is based on the style vector map. In some examples, text content adapter 730 is trained using a character recognition loss. Text style adapter 735 is an example of, or includes aspects of, the corresponding element described with reference to FIGS. 10 and 11.

According to some embodiments, background adapter 740 of the image generation model 725 encodes a background image to obtain background guidance information, where the synthesized image is generated based on the background guidance information. In some aspects, the background image indicates a location of the text.

According to some embodiments, background adapter 740 of the image generation model 725 is trained to encode a background image to obtain background guidance information, wherein the synthesized image is generated based on the background guidance information. Background adapter 740 is an example of, or includes aspects of, the corresponding element described with reference to FIG. 10.

According to some embodiments, text encoder 745 of the image generation model 725 encodes a text prompt to obtain text guidance information, where the synthesized image is generated based on the text guidance information. In some examples, text encoder 745 is a multi-modal encoder such as CLIP. CLIP (Contrastive Language-Image Pre-Training) model is a neural network trained on a variety of image-text pairs. Text encoder 745 is an example of, or includes aspects of, the corresponding element described with reference to FIGS. 10 and 11.

According to some embodiments, character recognition component 750 determines a character location of each character in the text content image, where the content guidance information is based on the character location.

According to some embodiments, image generator 755 performs a reverse diffusion process. In some aspects, the image generator 755 includes a diffusion model. Image generator 755 is an example of, or includes aspects of, the corresponding element described with reference to FIGS. 10 and 11.

According to some embodiments, training component 760 initializes an image generation model 725. In some examples, training component 760 obtains a training set including a ground-truth image, a text content image, and a text style image. Training component 760 trains, using the training set, the image generation model 725 to generate images that include text having a target text style from the text style image.

In some examples, training component 760 obtains a noise input and generates a noise prediction based on the noise input. Training component 760 computes a diffusion loss based on the noise prediction and the ground-truth image. Training component 760 updates parameters of the image generation model 725 based on the diffusion loss. In some examples, training component 760 computes a character recognition loss. Training component 760 updates parameters of the image generation model 725 based on the character recognition loss.

In some examples, training component 760 fixes parameters of image generator 755 of the image generation model 725. Training component 760 iteratively updates parameters of text content adapter 730 and text style adapter 735 of the image generation model 725. In some examples, training component 760 copies parameters of image generator 755 of the image generation model 725 to text content adapter 730 and text style adapter 735 of the image generation model 725. In some examples, training component 760 obtains a training background image. In some cases, training component 760 (shown in dashed line) is implemented on an apparatus other than image generation apparatus 700.

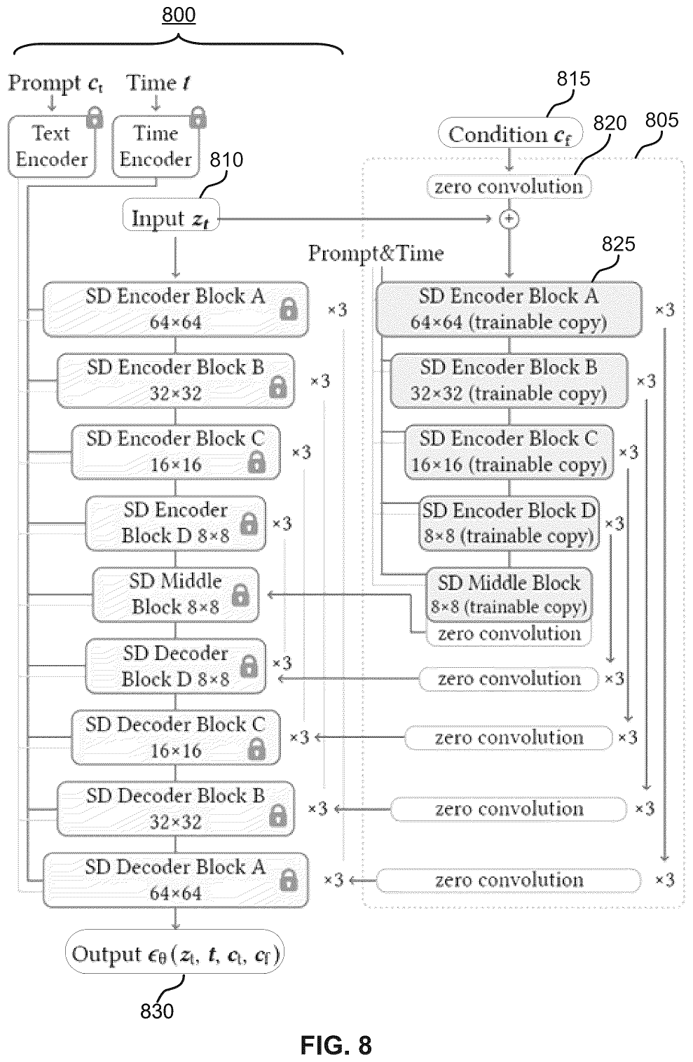

FIG. 8 shows an example of an image generation model comprising a control network 805 according to aspects of the present disclosure. The example shown includes U-Net 800, control network 805, noisy image 810, conditioning vector 815, zero convolution layer 820, trainable copy 825, and learned network 830.

ControlNet is a neural network structure to control image generation models by adding extra conditions. In some embodiments, a ControlNet architecture copies the weights from some of the neural network blocks of the image generation model to create a “locked” copy and a “trainable” copy 825. The “trainable” one learns your condition. The “locked” copy preserves the parameters of the original model. The trainable copy 825 can be tuned with a small dataset of image pairs, while preserving the locked copy ensures that original model is preserved.

As an example architecture shown in FIG. 8, the image generation model comprises U-Net 800 (the left-hand side) and control network 805 (the right-hand side). In some embodiments, a ControlNet architecture can be used to control a diffusion U-Net 800 (i.e., to add controllable parameters or inputs that influence the output). Encoder layers of the U-Net 800 can be copied and tuned. Then zero convolution layers can be added. The output of the control network 805 can be input to decoder layers of the U-Net 800.

In an embodiment, Stable Diffusion's U-Net is connected with a ControlNet on the encoder blocks and middle block. The locked blocks (light gray) show the structure of Stable Diffusion (U-Net architecture). The trainable copy blocks (dark gray) and the zero convolution layers are added to build a ControlNet. In some cases, trainable copy 825 may be referred to as a trainable copy block or a trainable block.

In some embodiments, one or more zero convolution layers (e.g., 820) are added to the trainable copy 825. A “zero convolution” layer 820 is 1×1 convolution with both weight and bias initialized as zeros. Before training, the zero convolution layers output all zeros. Accordingly, the ControlNet will not cause any distortion. As the training proceeds, the parameters of the zero convolution layers deviate from zero and the influence of the ControlNet on the output grows.

Given an input image z₀, image diffusion algorithms progressively add noise to the image and produce a noisy image zₜ, where t represents the number of times noise is added. Given a set of conditions including time step t, text prompts cₜ, as well as a task-specific condition c_{f}, image diffusion algorithms learn a network ϵ_{θ} to predict the noise added to the noisy image zₜ with:

$$L = {E}_{{z}_{0} , t , {c}_{t} , {c}_{f} , ϵ ∼ N ( 0 , 1 )} [ {‖ ϵ - ϵ ( {z}_{t} , t , {c}_{t} , {c}_{f} ) ‖}_{2}^{2} ] \qquad ( 1 )$$

where L is the overall learning objective of the entire diffusion model. This learning objective is directly used in fine-tuning diffusion models with ControlNet. The output from U-Net 800 includes parameters corresponding to learned network 830, e.g., output ϵ_{θ}(zₜ, t, cₜ, c_{f}).

Control network 805 is an example of, or includes aspects of, the corresponding element described with reference to FIGS. 7, and 10-11.

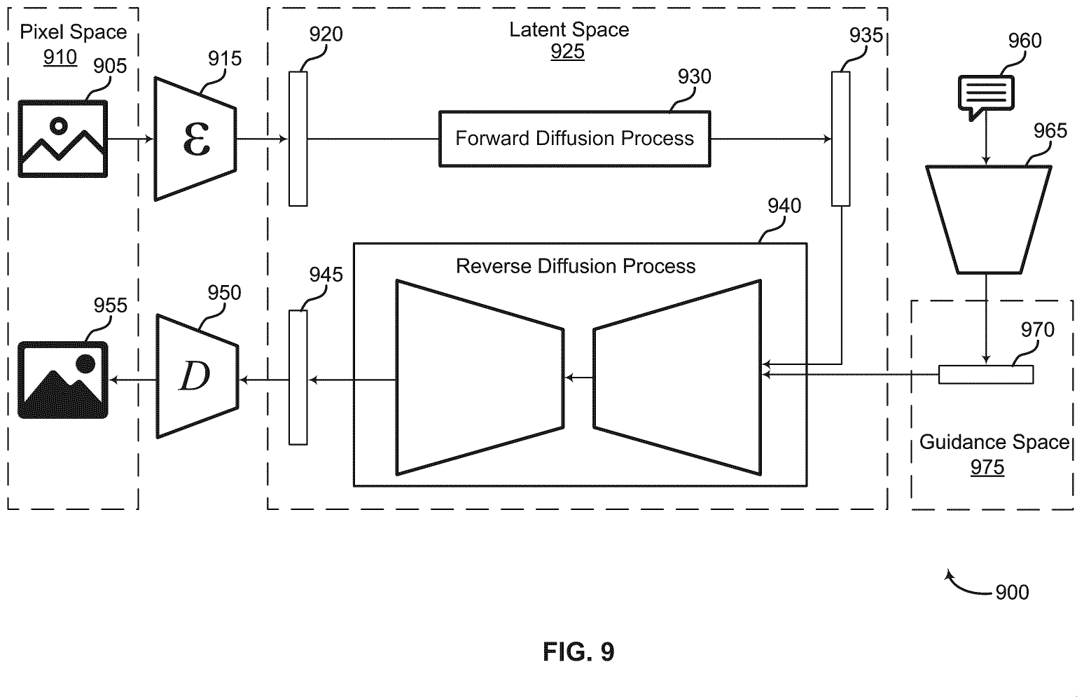

FIG. 9 shows an example of a guided latent diffusion model 900 according to aspects of the present disclosure. The guided latent diffusion model 900 depicted in FIG. 9 is an example of, or includes aspects of, the corresponding element described with reference to FIG. 7.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 900 may take an original image 905 in a pixel space 910 as input and apply and image encoder 915 to convert original image 905 into original image features 920 in a latent space 925. Then, a forward diffusion process 930 gradually adds noise to the original image features 920 to obtain noisy features 935 (also in latent space 925) at various noise levels.

Next, a reverse diffusion process 940 (e.g., a U-Net ANN) gradually removes the noise from the noisy features 935 at the various noise levels to obtain denoised image features 945 in latent space 925. In some examples, the denoised image features 945 are compared to the original image features 920 at each of the various noise levels, and parameters of the reverse diffusion process 940 of the diffusion model are updated based on the comparison. Finally, an image decoder 950 decodes the denoised image features 945 to obtain an output image 955 in pixel space 910. In some cases, an output image 955 is created at each of the various noise levels. The output image 955 can be compared to the original image 905 to train the reverse diffusion process 940.

In some cases, image encoder 915 and image decoder 950 are pre-trained prior to training the reverse diffusion process 940. In some examples, they are trained jointly, or the image encoder 915 and image decoder 950 and fine-tuned jointly with the reverse diffusion process 940.

The reverse diffusion process 940 can also be guided based on a text prompt 960, or another guidance prompt, such as an image, a layout, a segmentation map, etc. The text prompt 960 can be encoded using a text encoder 965 (e.g., a multimodal encoder) to obtain guidance features 970 in guidance space 975. The guidance features 970 can be combined with the noisy features 935 at one or more layers of the reverse diffusion process 940 to ensure that the output image 955 includes content described by the text prompt 960. For example, guidance features 970 can be combined with the noisy features 935 using a cross-attention block within the reverse diffusion process 940.

FIG. 10 shows an example of an image generation model 1000 according to aspects of the present disclosure. The example shown includes image generation model 1000, text content image 1005, text style image 1010, background image 1015, text content adapter 1020, text style adapter 1025, background adapter 1030, text encoder 1035, noise image 1040, image generator 1045, and synthesized image 1050. Image generation model 1000 is an example of, or includes aspects of, the corresponding element described with reference to FIGS. 4, 5, 7, and 11. In some cases, image generation model 1000 is an adapter-enhanced text-to-image diffusion model for text editing.

In some embodiments, image generation model 1000 includes image generator 1045 and multiple adapters. Image generator 1045 is a text-to-image model (e.g., U-Net) and the adapters include a text content adapter 1020, a text style adapter 1025, and a background adapter 1030. Text content adapter 1020, text style adapter 1025, and background adapter 1030 are configured to process different text image information. The implementation of image generation model 1000 disentangles the information for a text image, and accordingly, separate control of text editing or image generation is increased due to the adapters.

In some embodiments, text content adapter 1020 encodes text content image 1005 to obtain content guidance information. Text style adapter 1025 encodes text style image 1010 to obtain style guidance information. Background adapter 1030 encodes background image 1015 to obtain background guidance information. Text encoder 1035 encodes a text prompt to obtain text guidance information. For example, the text prompt is “a clean and sharp photo”. Image generator 1045 generates synthesized image 1050 based on the content guidance information, the style guidance information, the background guidance information, the text guidance information, and noise image 1040.

In some embodiments, image generator 1045 is a text-to-image diffusion model (e.g., Stable Diffusion), and three adapters (i.e., text content adapter 1020, text style adapter 1025, background adapter 1030) are initialized as a control network (also referred to as ControlNet or ControlNet adapter). In some examples, the control network includes the three adapters mentioned above. The ControlNet adapter is initialized using the weights of the down-sampling part of U-Net. Accordingly, the outputs of these adapters maintain the same spatial resolution as the intermediate hidden features within the U-Net. After encoding the outputs from the three adapters, some embodiments sum them with the hidden feature in U-Net to construct conditioned hidden features. Zero-convolution layers are added between each block, which ensures the output from the ControlNet is zeros at the first gradient step to stabilize training.

In some examples, image generation model 1000 is configured to construct the input text content map as a spatial-aware text segmentation map. Text content image 1005 may be rendered from a text engine or obtained from a text segmentation model. Text content image 1005 is an input to text content adapter 1020. Given a text image, a character recognition component (also referred to as an OCR model) is used to extract a bounding box for each visual character and then fill each pixel within the bounding box with a corresponding glyph id. Each pixel of the result text map contains the glyph ID, e.g. 1 for “a”, 2 for “b”, that represents the target character in the generated image at the same spatial location. The non-text background is represented using a null id, e.g., 0.

Similarly, the input text style map is constructed in a spatial-aware manner. Image generation model 1000 includes a style extractor (e.g., VGG-16 model) that encodes the input style reference into a 256-dimensional style vector. Then the style vector is padded into the specified location to construct the input style feature map. In some examples, text style image 1010 is provided and is input to the VGG style extractor to obtain the 256-dimensional style vector. Then the style vector is converted to a style feature map matching the text area in text content image 1005. The style feature map is fed into text style adapter 1025. The style feature map indicates a location of the text style in text style image 1010, where the style guidance information is based on the style feature map.

In some examples, the character recognition component determines a character location of each character in the text content image, where the content guidance information is based on the character location.

In some embodiments, image generation model 1000 may be modified to a different text-to-image generative model and adapter architectures. Some embodiments can extend to include additional adapter(s) processing more fine-grained information such as font type, stroke thickness, etc.

Text content adapter 1020 is an example of, or includes aspects of, the corresponding element described with reference to FIGS. 7 and 11. Text style adapter 1025 is an example of, or includes aspects of, the corresponding element described with reference to FIGS. 7 and 11. Background adapter 1030 is an example of, or includes aspects of, the corresponding element described with reference to FIG. 7. Text encoder 1035 is an example of, or includes aspects of, the corresponding element described with reference to FIGS. 7 and 11. Image generator 1045 is an example of, or includes aspects of, the corresponding element described with reference to FIGS. 7 and 11.

Text content image 1005 is an example of, or includes aspects of, the corresponding element described with reference to FIGS. 5 and 11. Text style image 1010 is an example of, or includes aspects of, the corresponding element described with reference to FIGS. 5 and 11. Noise image 1040 is an example of, or includes aspects of, the corresponding element described with reference to FIG. 11. Synthesized image 1050 is an example of, or includes aspects of, the corresponding element described with reference to FIGS. 4, 5, and 11.

FIG. 11 shows an example of an image generation model 1100 according to aspects of the present disclosure. The example shown includes image generation model 1100, text content image 1105, text style image 1110, text content adapter 1115, text style adapter 1120, text encoder 1125, noise image 1130, image generator 1135, and synthesized image 1140. Image generation model 1100 is an example of, or includes aspects of, the corresponding element described with reference to FIGS. 4, 5, 7, and 10. In some cases, image generation model 1100 is an adapter-enhanced diffusion model for text-to-image generation.

In some embodiments, text content adapter 1115 encodes text content image 1105 to obtain content guidance information. Text style adapter 1120 encodes text style image 1110 to obtain style guidance information. Here, a background adapter is deactivated. Text encoder 1125 encodes a text prompt to obtain text guidance information. For example, the text prompt is “a close-up shot of a cup saying with the text keep calm and let the engineer handle it”. Image generator 1135 generates synthesized image 1140 based on the content guidance information, the style guidance information, the text guidance information, and noise image 1130.

Referring to FIGS. 10-11, an image generation model can perform text-editing tasks with three adapters activated and text-to-image generation tasks with just text content adapter and text style adapter activated. User control of the text-to-image generation process is increased.

Text content adapter 1115 is an example of, or includes aspects of, the corresponding element described with reference to FIGS. 7 and 10. Text style adapter 1120 is an example of, or includes aspects of, the corresponding element described with reference to FIGS. 7 and 10. Text encoder 1125 is an example of, or includes aspects of, the corresponding element described with reference to FIGS. 7 and 10. Image generator 1135 is an example of, or includes aspects of, the corresponding element described with reference to FIGS. 7 and 10.

Text content image 1105 is an example of, or includes aspects of, the corresponding element described with reference to FIGS. 5 and 10. Text style image 1110 is an example of, or includes aspects of, the corresponding element described with reference to FIGS. 5 and 10. Noise image 1130 is an example of, or includes aspects of, the corresponding element described with reference to FIG. 10. Synthesized image 1140 is an example of, or includes aspects of, the corresponding element described with reference to FIGS. 4, 5, and 10.

In some examples, diffusion models are based on a neural network architecture known as a U-Net. The U-Net takes input features having an initial resolution and an initial number of channels, and processes the input features using an initial neural network layer (e.g., a convolutional network layer) to produce intermediate features. The intermediate features are then down-sampled using a down-sampling layer such that down-sampled features have a resolution less than the initial resolution and a number of channels greater than the initial number of channels.

This process is repeated multiple times, and then the process is reversed. That is, the down-sampled features are up-sampled using up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features could include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt describing content to be included in a generated image. For example, a user may provide the prompt “a person playing with a cat”. In some examples, guidance can be provided in a form other than text, such as via an image, a sketch, or a layout. The system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the system generates an image based on the noise map and the conditional guidance vector.

A diffusion process can include both a forward diffusion process for adding noise to an image (or features in a latent space) and a reverse diffusion process for denoising the images (or features) to obtain a denoised image. The forward diffusion process can be represented as q(xₜ|xₜ₋₁), and the reverse diffusion process can be represented as p(xₜ₋₁|xₜ). In some cases, the forward diffusion process is used during training to generate images with successively greater noise, and a neural network is trained to perform the reverse diffusion process (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process, the model begins with noisy data x_{T}, such as a noisy image and denoises the data to obtain the p(xₜ₋₁|xₜ). At each step t−1, the reverse diffusion process takes xₜ, such as first intermediate image, and t as input. Here, t represents a step in the sequence of transitions associated with different noise levels, The reverse diffusion process outputs xₜ₋₁, such as second intermediate image iteratively until x_{T} is reverted back to x₀, the original image. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 2 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 3 )$$

where p(x_{T})=N(x_{T}; 0, I) is the pure noise distribution as the reverse process takes the outcome of the forward process, a sample of pure noise, as input and Πₜ₌₁^{T} p_{θ}(xₜ₋₁|xₜ) represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and z represents the generated image with high image quality.

A diffusion model may be trained using both a forward and a reverse diffusion process. In one example, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

The system then adds noise to a training image using a forward diffusion process in N stages. In some cases, the forward diffusion process is a fixed process where Gaussian noise is successively added to an image. In latent diffusion models, the Gaussian noise may be successively added to features in a latent space.

At each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

The training system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data. The training system then updates parameters of the model based on the comparison. For example, parameters of a U-Net may be updated using gradient descent. Time-dependent parameters of the Gaussian transitions can also be learned.

### Training and Evaluation

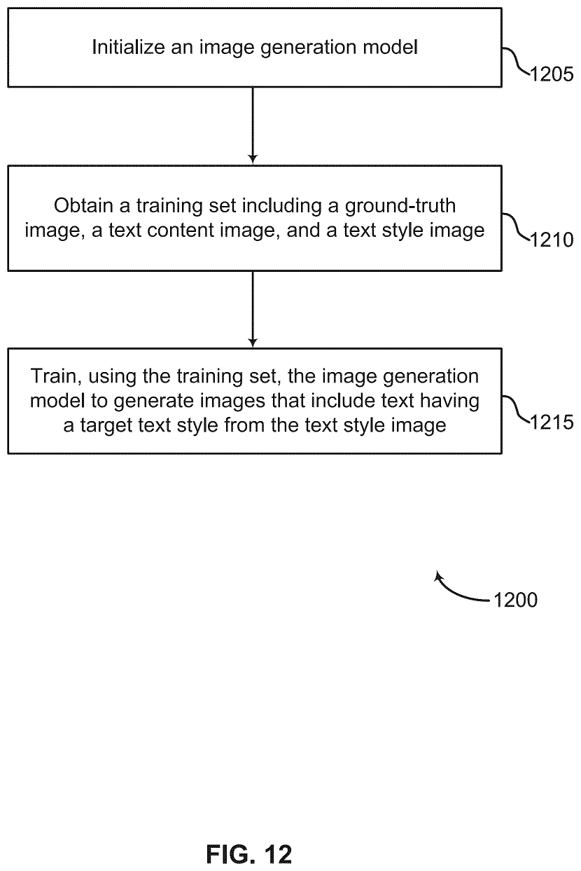

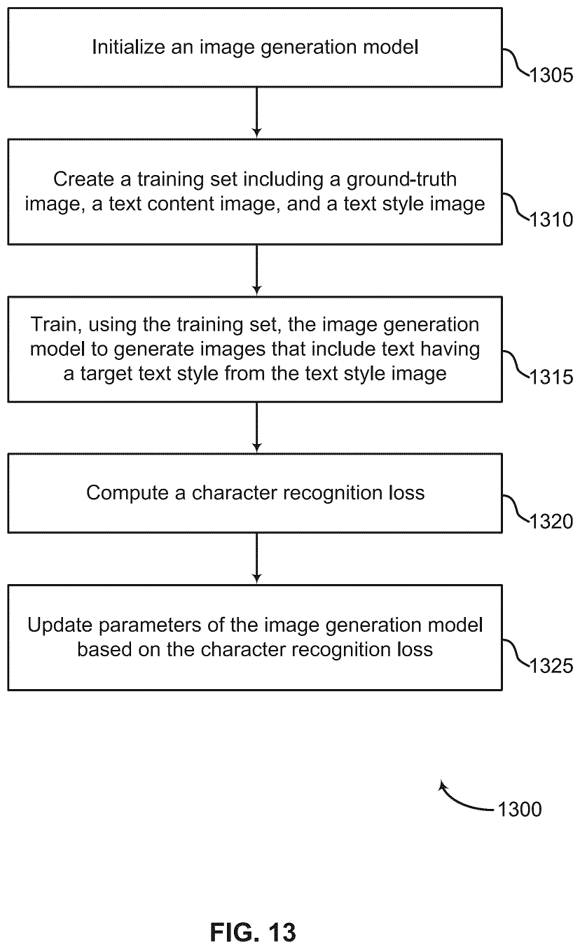

In FIGS. 12-13, a method, apparatus, and non-transitory computer readable medium for image generation are described. One or more embodiments of the method, apparatus, and non-transitory computer readable medium include initializing an image generation model; obtaining a training set including a ground-truth image, a text content image, and a text style image; and training, using the training set, the image generation model to generate images that include text having a target text style from the text style image.

Some examples of the method, apparatus, and non-transitory computer readable medium further include obtaining a noise input and generating a noise prediction based on the noise input. Some examples further include computing a diffusion loss based on the noise prediction and the ground-truth image. Some examples further include updating parameters of the image generation model based on the diffusion loss.

Some examples of the method, apparatus, and non-transitory computer readable medium further include computing a character recognition loss. Some examples further include updating parameters of the image generation model based on the character recognition loss.

Some examples of the method, apparatus, and non-transitory computer readable medium further include fixing parameters of an image generator of the image generation model. Some examples further include iteratively updating parameters of a text content adapter and a text style adapter of the image generation model.

Some examples of the method, apparatus, and non-transitory computer readable medium further include copying parameters of an image generator of the image generation model to a text content adapter and a text style adapter of the image generation model.

Some examples of the method, apparatus, and non-transitory computer readable medium further include obtaining a training background image. Some examples further include extracting a text content location from the training background image, wherein the image generation model is trained to generate the images based on the training background image and the text content location.

FIG. 12 shows an example of a method 1200 for training an image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1205, the system initializes an image generation model. In some cases, the operations of this step refer to, or may be performed by, a training component as described with reference to FIG. 7. In some examples, the image generation model is initialized using random values. In other examples, the image generation model is initialized based on a pre-trained model. In some examples, the image generation model includes base parameters from a pre-trained model and additional parameters (i.e., adapter parameters) that are added to the pre-trained model for fine-tuning. In this case, the additional parameters are initialized randomly and trained during a fine-tuning phase while the parameters from the base model are fixed during the fine-tuning phase.

In one example, weights and parameters of an original image generator (e.g., a diffusion model) are fixed at training time and only adapter parameters are updated. For example, the image generator is pre-trained on web scale real images. In some embodiments, the training component (with reference to FIG. 7) is used to optimize the weights of the adapters, i.e., the text content adapter, the text style adapter, and the background adapter.

At operation 1210, the system obtains a training set including a ground-truth image, a text content image, and a text style image. In some cases, the operations of this step refer to, or may be performed by, a training component as described with reference to FIG. 7.

In some cases, obtaining a training set can include creating training data for training the image generation model. In some examples, a text content image includes one or more characters that are target characters in a generated image at the same spatial location. The text content image may be rendered from a text engine or obtained from a text segmentation model (as a text content map or a spatial-aware text segmentation map). The text content image is input to a text content adapter. A text style image includes a target style (e.g., font). The text style image is input to a style extractor to get a style vector. Then the style vector is converted to a style feature map matching the text area in a corresponding text content image.

At operation 1215, the system trains, using the training set, the image generation model to generate images that include text having a target text style from the text style image. In some cases, the operations of this step refer to, or may be performed by, a training component as described with reference to FIG. 7.

For example, if the image generation model is a diffusion model, operation 1215 may include obtaining a noise input, generating a noise prediction based on the noise input, computing a diffusion loss based on the noise prediction and the ground-truth image; and updating parameters of the image generation model based on the diffusion loss.

In some embodiments, during training, the training component fixes the weights of the image generator of the image generation model. The training component updates and optimizes the weights of the text content adapter, the text style adapter, and the background adapter. Following standard diffusion training, the training component samples a timestep t, and adds noise ϵ∈N(0, σ(t)) to a ground-truth text image x to construct noisy input x′, where σ(t) is the noise level schedule used by the diffusion model. The image generation model is trained to predict the added noise conditioned on instruction c, text content map cₜₑₓₜ, text style map c_{style}, and background reference image c_{bg}=×0 m, where m is a mask indicating the location of foreground text and the background image. The loss function L includes a diffusion loss (e.g., mean square error or MSE loss) and a character recognition loss. MSE loss is short for mean-squared error loss. The character recognition loss is also referred to as OCR loss. The character recognition loss improves text correctness. The overall objective function L is formulated as follows:

$$ℒ = \underbrace{{‖ ϵ - {ϵ}_{θ} ( {x}^{′} , t , c , {c}_{text} , {c}_{style} , {c}_{bg} ) ‖}^{2}}_{Diffusion Loss} + \underbrace{{αℒ}_{CE} ( OCR ( g ( {x}^{′} , t , {ϵ}_{θ} ( {x}^{′} , t , c , {c}_{text} , {c}_{style} , {c}_{bg} ) ) ) , {c}_{text} )}_{OCR Loss} \qquad ( 4 )$$

where α is the weight to control the scale of OCR loss, ϵ_{θ}(·) is model prediction and g(·) is a one-step approximation of the final diffusion generation following DDIM formulation.

In the fields of regression analysis and machine learning, the mean square error is a crucial metric for evaluating the performance of predictive models. In some examples, MSE measures the average squared difference between the predicted and the actual target values within a dataset. The primary objective of the MSE is to assess the quality of a model's predictions by measuring how closely they align with the ground truth.

FIG. 13 shows an example of a method 1300 for training an image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the system initializes an image generation model. In some cases, the operations of this step refer to, or may be performed by, a training component as described with reference to FIG. 7. In an embodiment, the image generation model includes a text-to-image generator (e.g., U-Net) and one or more adapters. The weights of the image generator are fixed. The one or more adapters include a text content adapter, a text style adapter, and a background adapter.

At operation 1310, the system obtains a training set including a ground-truth image, a text content image, and a text style image. In some cases, the operations of this step refer to, or may be performed by, a training component as described with reference to FIG. 7. In some cases, obtaining a training set can include creating training data for training the image generation model.

At operation 1315, the system trains, using the training set, the image generation model to generate images that include text having a target text style from the text style image. In some cases, the operations of this step refer to, or may be performed by, a training component as described with reference to FIG. 7.

At operation 1320, the system computes a character recognition loss. In some cases, the operations of this step refer to, or may be performed by, a training component as described with reference to FIG. 7. The character recognition loss may be referred to as OCR loss. The character recognition loss is formulated as [symbol] _{CE}(OCR(g(x′, t, ϵ_{θ}(x′, t, c, cₜₑₓₜ, c_{style}, c_{bg}))), cₜₑₓₜ). Herein, ϵ_{θ}(·) is the model prediction and g(·) is a one-step approximation of the final diffusion generation following DDIM formulation. ϵ_{θ}(·) is computed based on noisy input x′, time step t, text prompt c, text content map cₜₑₓₜ, text style c_{style}, and background reference image c_{bg}.

At operation 1325, the system updates parameters of the image generation model based on the character recognition loss. In some cases, the operations of this step refer to, or may be performed by, a training component as described with reference to FIG. 7. At training, the weights of three adapters are adjusted and optimized based on the character recognition loss. The character recognition loss is used to improve text correctness.

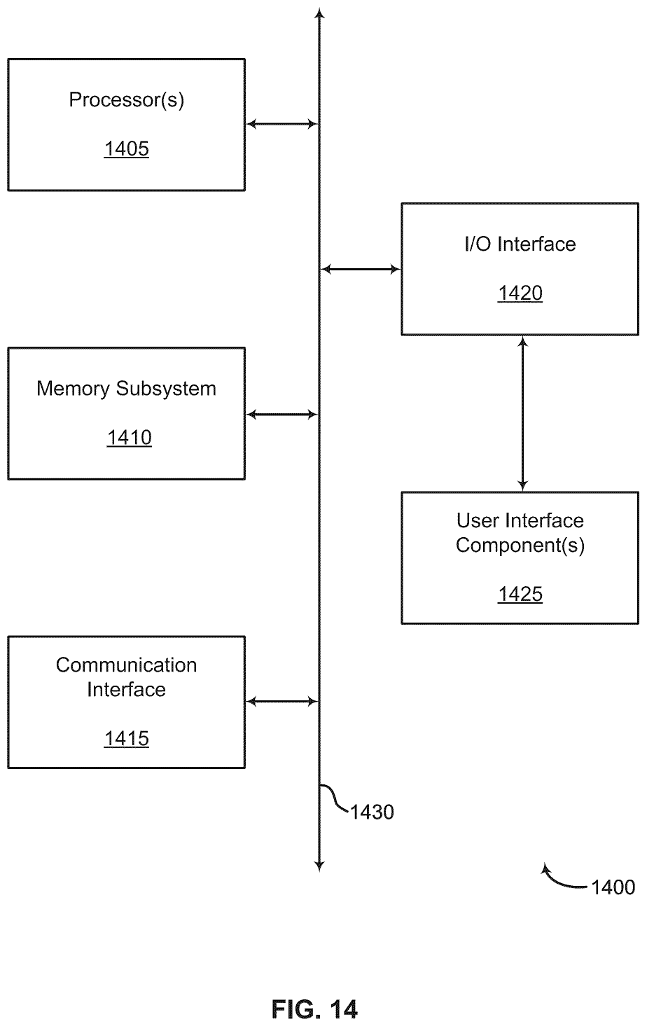

FIG. 14 shows an example of a computing device 1400 according to aspects of the present disclosure. The example shown includes computing device 1400, processor(s) 1405, memory subsystem 1410, communication interface 1415, I/O interface 1420, user interface component(s) 1425, and channel 1430. In one embodiment, computing device 1400 includes processor(s) 1405, memory subsystem 1410, communication interface 1415, I/O interface 1420, user interface component(s) 1425, and channel 1430.

In some embodiments, computing device 1400 is an example of, or includes aspects of, image generation apparatus 110 of FIG. 1. In some embodiments, computing device 1400 includes one or more processors 1405 that can execute instructions stored in memory subsystem 1410 to obtain a text content image and a text style image; encode, using a text content adapter of an image generation model, the text content image to obtain content guidance information; encode, using a text style adapter of the image generation model, the text style image to obtain style guidance information; and generate, using the image generation model, a synthesized image based on the content guidance information and the style guidance information, wherein the synthesized image includes text from the text content image having a text style from the text style image.

According to some embodiments, computing device 1400 includes one or more processors 1405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some embodiments, memory subsystem 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some embodiments, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna.

According to some embodiments, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or via hardware components controlled by the I/O controller.

According to some embodiments, user interface component(s) 1425 enable a user to interact with computing device 1400. In some cases, user interface component(s) 1425 include an audio device, such as an external speaker system, an external display device such as a display screen, an input device (e.g., a remote control device interfaced with a user interface directly or through the I/O controller), or a combination thereof. In some cases, user interface component(s) 1425 include a GUI.

Performance of apparatus, systems and methods of the present disclosure have been evaluated, and results indicate embodiments of the present disclosure have obtained increased performance over existing technology. Example experiments demonstrate that the image generation apparatus described in embodiments of the present disclosure outperforms conventional systems.

In some example experiments, the image generation apparatus based on the present disclosure is evaluated by measuring text correctness using OCR tools and style correctness using the text part MSE for the text-editing task. The image generation model is compared to base diffusion model (also referred to as foundation model). The image generation model greatly improves upon the base diffusion model in generating correct text content and style with more than 50 percent improvement in word accuracy. Having combined the text style adapter with an image generator, the image generation model encodes image space style information of the target style instead of relying on the text description of the target style for the diffusion model, which greatly improves style correctness.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a text content image and a text style image;
encoding, using a text content adapter of an image generation model, the text content image to obtain content guidance information;
encoding, using a text style adapter of the image generation model, the text style image to obtain style guidance information; and
generating, using the image generation model, a synthesized image based on the content guidance information and the style guidance information, wherein the synthesized image includes text from the text content image having a text style from the text style image.

2. The method of claim 1, further comprising:
encoding, using a background adapter of the image generation model, a background image to obtain background guidance information, wherein the synthesized image is generated based on the background guidance information.

3. The method of claim 2, wherein:
the background image indicates a location of the text.

4. The method of claim 1, further comprising:
encoding, using a text encoder of the image generation model, a text prompt to obtain text guidance information, wherein the synthesized image is generated based on the text guidance information.

5. The method of claim 1, further comprising:
determining, using a character recognition component, a character location of each character in the text content image, wherein the content guidance information is based on the character location.

6. The method of claim 1, further comprising:
generating a style vector map that indicates a location of the text style in the text style image, wherein the style guidance information is based on the style vector map.

7. The method of claim 1, wherein generating the synthesized image comprises:
performing a reverse diffusion process.

8. The method of claim 1, wherein generating the synthesized image comprises:
providing the content guidance information and the style guidance information to an up-sampling layer of the image generation model.

9. The method of claim 1, wherein:
the text content adapter is trained using a character recognition loss.

10. A method comprising:
obtaining a training set including a ground-truth image, a text content image, and a text style image; and
training, using the training set, an image generation model to generate images that include text having a target text style from the text style image.

11. The method of claim 10, wherein training the image generation model comprises:
obtaining a noise input;
generating a noise prediction based on the noise input;
computing a diffusion loss based on the noise prediction and the ground-truth image; and
updating parameters of the image generation model based on the diffusion loss.

12. The method of claim 10, wherein training the image generation model comprises:
computing a character recognition loss; and
updating parameters of the image generation model based on the character recognition loss.

13. The method of claim 10, wherein training the image generation model comprises:
fixing parameters of an image generator of the image generation model; and
iteratively updating parameters of a text content adapter and a text style adapter of the image generation model.

14. The method of claim 10, wherein initializing the image generation model comprises:
copying parameters of an image generator of the image generation model to a text content adapter and a text style adapter of the image generation model.

15. The method of claim 10, wherein obtaining the training set comprises:
obtaining a training background image; and
extracting a text content location from the training background image, wherein the image generation model is trained to generate the images based on the training background image and the text content location.

16. An apparatus comprising:
at least one processor;
at least one memory including instructions executable by the at least one processor; and
a machine learning model comprising parameters in the at least one memory, wherein the machine learning model comprises:
a text content adapter of an image generation model trained to encode a text content image to obtain content guidance information;
a text style adapter of the image generation model trained to encode a text style image to obtain style guidance information; and
an image generator of the image generation model trained to generate a synthesized image based on the content guidance information and the style guidance information, wherein the synthesized image includes text from the text content image and a text style from the text style image.

17. The apparatus of claim 16, wherein the machine learning model further comprises:
a background adapter of the image generation model trained to encode a background image to obtain background guidance information, wherein the synthesized image is generated based on the background guidance information.

18. The apparatus of claim 16, wherein:
the text content adapter and the text style adapter comprise a control network that is initialized using parameters from the image generator.

19. The apparatus of claim 16, wherein:
the image generator comprises a diffusion model.

20. The apparatus of claim 16, further comprising:
a multi-modal encoder configured to encode a text prompt to obtain text guidance information, wherein the synthesized image is generated based on the text guidance information.
